(19) United States
(12) Patent Application Publication
(10) Pub. No.: US 2003/0182090 A1
(43) Pub. Date: Sep. 25, 2003

(54) System and method for processing a complex feature

(75) Inventors: Suzanne B. Paladini, Huntington Beach, CA (US); Shrinivas M. Soman, Cypress, CA (US); David M. Kailiponi, Cypress, CA (US)

Correspondence Address: BAKER BOTTS L.L.P., 2001 ROSS AVENUE, SUITE 600, DALLAS, TX, 75201-2980, US

(73) Assignee: Electronic Data Systems

(21) Appl. No.: 10/105,479

(22) Filed: Mar. 20, 2002

(51) Int. Cl. G06F 17/50

(52) U.S. Cl. 703/1

(57) ABSTRACT

A method for processing a complex feature includes selecting a first feature, wherein the first feature comprises a plurality of faces. A second feature, wherein the second feature comprises a plurality of faces, is selected. The presence of a complex feature is automatically determined based on a relationship of the selected first and second features. One or more tolerances of the complex feature are determined.

### TECHNICAL FIELD OF THE INVENTION

The present invention relates generally to data processing systems and, more particularly, to a system and method for processing a complex feature in a computer aided design (CAD) or engineering data management (EDM) system.

### BACKGROUND OF THE INVENTION

Computer aided design systems provide useful environments for designers of mechanical components to specify the physical characteristics and configurations of various components within complex assemblies. Sophisticated computer aided design systems have also been able to provide designers with the ability to specify other information related to the construction and testing of these components. For example, some sophisticated computer aided design systems allow for the designer to specify the type of material to be used to construct a particular component, the tolerance associated with various dimensions of the component, processing techniques to be used to manufacture the component and other characteristics associated with the manufacture, testing, or use of components of the assembly. In cases where tolerance features are different, but related, such as for counterbore and threaded holes, customers need the ability to create a single display instance.

### SUMMARY OF THE INVENTION

Accordingly, a need has arisen for a computer aided design system and method of operation that allows various features to be coupled as a complex feature and tolerances to be associated with the complex feature.

In accordance with one embodiment of the present invention, a method for tolerancing a complex feature includes selecting a first feature, wherein the first feature comprises a plurality of faces. A second feature, wherein the second feature comprises a plurality of faces, is selected. The presence of a complex feature is automatically determined based on a relationship of the selected first and second features. One or more tolerances of the complex feature may then be determined based on the relationship of the subordinate features.

Technical advantages of one or more embodiments of the present invention include allowing tight integration of various features into more complex features. Another technical advantage might include data encapsulation. Yet another technical advantage might be the ability to create graphical representation of tolerances as per the national and industry standards. The present invention may also provide the ability to create a single display instance for a set of related, yet non-pattern, tolerance features.

These and elsewhere described technical advantages may be present in some, none, or all of the embodiments of the present invention. In addition, other technical advantages of the present invention will be readily apparent to one skilled in the art from the following figures, description, and claims.

### BRIEF DESCRIPTION OF THE DRAWINGS

For a more complete understanding of the present invention and its advantages, reference is now made to the following descriptions, taken in conjunction with the accompanying drawings, in which:

FIG. 1 is a diagram illustrating a complex feature in a CAD or EDM system in accordance with one embodiment of the present invention;

FIG. 2 is a block diagram illustrating a system for creating a complex feature in accordance with one embodiment of the present invention;

FIG. 3 is a block diagram illustrating a complex feature in accordance with one embodiment of the present invention;

FIG. 4 is a flow diagram illustrating a method for creating a complex feature in accordance with one embodiment of the present invention;

FIG. 5 is a flow diagram illustrating a method for selecting a stepped shaft or hole of the complex feature of FIG. 4 in accordance with one embodiment of the present invention;

FIG. 6 is a flow diagram illustrating a method for selecting a cylindrical face of the stepped shaft or hole of FIG. 5 in accordance with one embodiment of the present invention;

FIG. 7 is a flow diagram illustrating a method for selecting one or more adjoining faces of the stepped shaft or hole of FIG. 5 in accordance with one embodiment of the present invention;

FIG. 8 is a flow diagram illustrating a method for selecting an elongated hole of the complex feature of FIG. 4 in accordance with one embodiment of the present invention;

FIG. 9 is a flow diagram illustrating a method for selecting the elongated hole faces from one planar face of the complex feature of FIG. 8 in accordance with one embodiment of the present invention; and

FIG. 10 is a flow diagram illustrating a method for selecting the elongated hole faces from one cylindrical face of the complex feature of FIG. 8 in accordance with one embodiment of the present invention.

### DETAILED DESCRIPTION OF THE INVENTION

FIG. 1 is a diagram illustrating a complex feature 850 in a CAD system in accordance with one embodiment of the present invention. FIG. 1 includes cylinder 800, complex feature 850, and complex tolerance feature 825. Cylinder 800 is exemplary of any material or shape in which complex feature 850 may be designed to fit in or be related to.

Complex feature 850 includes two subfeatures, counterbore hole 855 and hole 860. As used herein, a “feature” is a physical portion of a part, including a surface, pin, tab, hole, or slot. A “complex feature” is created when a first feature is associated with one or more additional features. Further, as used herein, a “subfeature” may be a feature that is a component of the complex feature. For example, complex feature 850 is an association of counterbore hole 855 with hole 860. It will be understood that complex feature 850 is for exemplary purposes only and may represent any complex feature that includes two or more associated subfeatures. Furthermore, the subfeatures may be associated in any order or with any number of other features. It will be further understood that complex feature 850 may be different from a pattern feature where the different objects of a pattern feature are similar. An example of a pattern feature may include a first plate with four screws in it. A second plate might have four corresponding holes in it. Each plate might be considered a pattern feature.

In this embodiment, complex feature 850 is related to a complex tolerance 825. A “tolerance” may be a set of instructions on how a related feature is manufactured or inspected. For example, a depth tolerance for counterbore hole 855 may include the desired depth of 0.5 inches and the limited variation of 0.05 inches. This leaves the acceptable range for the depth of counterbore hole 855 to be from 0.45 inches to 0.55 inches.

As described in FIG. 3, a complex tolerance feature may include a tolerance 212 and one or more child tolerances 216. The tolerance 212 may include a feature control frame that tolerances a feature through the use of datums. A “datum” is a theoretically specific axis or plane that restricts a degree of freedom of a feature. For example, the central vertical axis of hole 860 may be used as a datum for counterbore hole 855, thus serving as a reference against which the tilt angle of counterbore hole 855 relative to a vertical angle may be restricted. In one embodiment, the datum reference frame 826 is a logical relation of datums that assist the system in defining a tolerance for the complex feature 850. Each child tolerance 216 may include geometry and associated tolerance information for a feature that is a subfeature of the complex feature 850. The CAD system may display the tolerance information for a tolerance 212 and several child tolerances 216. Thus, the system groups a set of child tolerances 216 and tolerance 212 together into a complex tolerance 825 so a single display instance may be generated. The complex tolerance 825 is associated with the complex feature 850.

As shown in FIG. 3, complex tolerance feature 825 includes one or more child tolerances 216 that are logically related to complex feature 850. In one embodiment, complex tolerance 825 includes hole tolerance 810, position tolerance frame 820, counterbore tolerance 830, and perpendicularity tolerance frame 840. It will be understood that complex tolerance 825 is for exemplary purposes only and may include any number of tolerances 212, in any suitable format, and in any suitable order.

Hole tolerance 810 represents one embodiment of the size tolerance 260 in FIG. 3. Hole tolerance 810 includes diameter icon 812, diameter value 814, diameter tolerance 816, depth icon 817, depth value 818, and depth tolerance 819. In this embodiment, the depth value 818 is determined from the top of cylinder 800 to the bottom plane of hole 860. In another embodiment, depth value 815 could be determined from the bottom plane of counterbore hole 855 to the bottom plane of hole 860.

Position tolerance 820 represents one embodiment of the feature control frame 265 in FIG. 3. Position tolerance 820 includes position icon 822, position tolerance 824, and datum reference frame 826. There are a variety of formats and datums that may be included in datum reference frame 826.

Counterbore tolerance 830 includes counterbore icon 831, diameter icon 832, diameter value 833, diameter tolerance 834, depth icon 835, depth value 836, and depth tolerance 837. Counterbore tolerance 830 is for exemplary purposes only and any suitable tolerance 27 may be used.

Perpendicularity tolerance frame 840 includes perpendicularity icon 841, perpendicularity tolerance 842, and an exemplary partial datum reference frame 843. Partial datum reference frame 843 includes one datum that may include a plane relative to which perpendicularity tolerance 842 may be measured. In another example datum reference frame 843 may include the axis from which perpendicularity tolerance 842 may be measured.

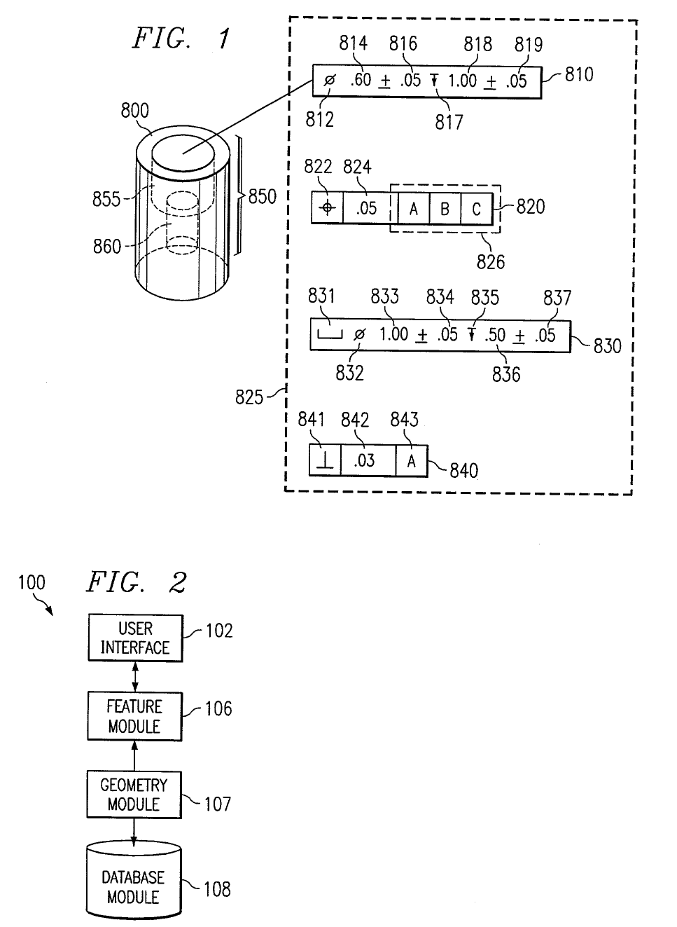

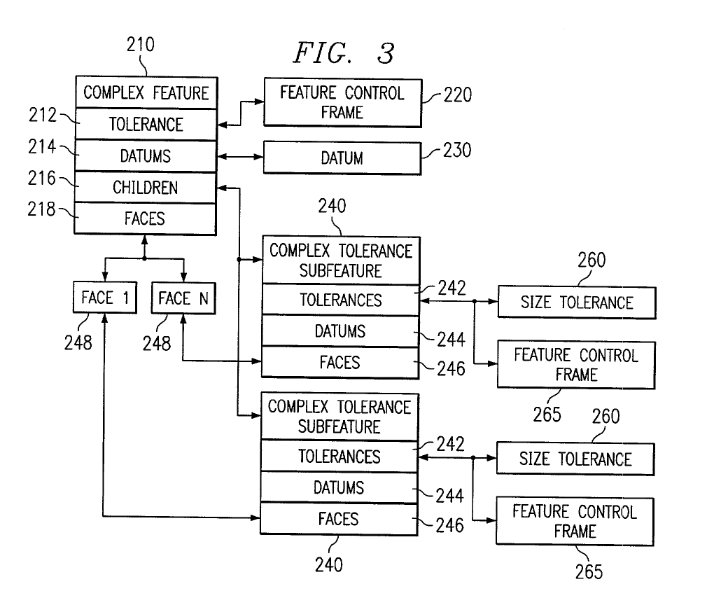

FIG. 2 is a block diagram illustrating a system 100 for defining a complex feature in accordance with one embodiment of the present invention. System 100 includes user interface 102, feature mode 106, geometry module 107, and database module 108. User interface 102 is communicably connected to feature module 106. Feature module 106 is communicably connected to geometry module 107 and database module 108. Further, geometry module 107 is communicably connected to database module 108. It will be understood that system 100 contemplates that the user interface 102, the feature mode 106, the geometry module 107, and the database module 108 may individually or jointly reside on one or more computer systems, whether workstations or servers.

According to one embodiment of the present invention, system 100 may comprise a portion of a computer aided design (CAD) system or an engineering data management (EDM) system. CAD systems are ordinarily associated with the design of an assembly, whereas EDM systems are ordinarily associated with the management of design data and related parameters after design, during, for example, manufacture or testing of the assembly. In these embodiments, the user interface 102 is operable to present graphical images of components of assemblies which are designed, modeled, or managed using the system 100.

User interface 102 is operable to display data and receive commands from a user which is interfacing with system 100. User interface 102 may comprise a software application or a portion of a data processing system that may include a computer screen, computer keyboard, and a pointing device such as a mouse or a track ball. Using these systems, a graphical display can be presented to a user and the user can type in commands or terms and use the pointing device to select active portions of the screen to institute actions or select items on the screen.

Feature module 106 includes objects, methods, functions, or any other logic that may manipulate features. In one embodiment of the present invention, feature module 106 may examine a feature selected at user interface 102 and gather the tolerance information for the selected feature. In this or another embodiment, the feature module 106 may use geometry or any other data to manipulate features.

Geometry module 107 includes objects, methods, functions, or any other logic that may manipulate basic and complex geometric relationships. In one embodiment of the present invention, geometry module 107 may examine two or more features and determine the presence of a complex feature.

Database module 108 includes computer records that may be generally identified by tables. It will be understood that the computer records may be otherwise combined and/or divided within the scope of the present invention. In this embodiment of the present invention, database module 108 includes basic face geometry of a plurality of features and a rules file.

FIG. 3 is a block diagram illustrating a complex feature 210 in accordance with one embodiment of the present invention. In one embodiment of the present invention, complex feature 210 includes tolerance 212, datums 214, one or more children 216, and a plurality of faces 218. Tolerance 212 comprises a feature control frame 220. The feature control frame 220 may include a datum reference frame.

As described with reference to FIG. 1, a “datum” is a theoretically specific axis or plane that restricts a degree of freedom of a feature. For example, the central vertical axis of hole 860 may be used as a datum for counterbore hole 855, thus restricting the tilt angle of counterbore hole 855 to a vertical angle.

Each datum may include a datum feature or a plurality of datum targets. A “datum feature” is a physical portion of a part that is used as a restriction on degree of freedom. For example, a datum feature may comprise a plane, a slot, a pin, a tapered pin, an elongated hole, a torus, a ball/socket, revolved, bounded, a thickness, or any other feature capable of restricting a degree of freedom. In this embodiment, a datum feature might be the plane comprising the top of cylinder 800. This plane restricts the vertical movement of counterbore hole 855 along a vertical axis perpendicular to the plane. Each datum feature includes a plurality of faces that may represent the sides of the feature. The “datum target” is a defined geometric point in space that may be used to define a datum. For example, three datum targets are required to define a plane and two datum targets are required to define an axis to be used as a datum. Once defined, the datum defined by the targets generating the plane may then be used to restrict the vertical movement of counterbore hole 855 along a vertical axis perpendicular to the plane.

Further, each datum requires either a theoretically specific plane or axis. The plane or axis may be inferred from either the datum feature faces, from the datum targets, or specified by the user. It will be understood that a datum may be defined by a function, data structure, or any other logic that might restrict a degree of freedom of any feature, complex or simple.

In one embodiment of the present invention, complex feature 210 includes one or more child features 216. Each child feature 216 comprises a complex tolerance subfeature 240. A complex tolerance subfeature 240 includes one or more tolerances 242, one or more datums 244, and one or more faces 246. Each of the tolerances 242 may include a size tolerance 260 or a feature control frame 265. Size tolerance 260 may include a tolerance type, such as diameter or depth, a desired quantitative measurement for the tolerance type, and a tolerance value. The feature control frame 265 may include a datum reference frame comprising one or more datums 214. Each face 246 is related to one face selected from face 248-1 through face 248-n. Consequently, every face that comprises the complex feature 210 is included in a face 246 in a child feature 216. Two example tables follow that demonstrate different sets of tolerances 212 and 216 available to the complex feature 210. Each row in the tables represents a valid set of one or more tolerances for a complex feature 210. For example, the first row of the counterbore hole table demonstrates that a child hole size tolerance alone is a valid set with or without a parent feature control frame. It will be understood that the tables are for example only and do not limit the set of tolerances 212 and 216 available to the complex feature 210.

| Counterbore Hole | | | | | | |
|---|---|---|---|---|---|---|
| Complex | | | | | | |
| Tolerance Feature | Counterbore Subfeature | | | Hole Subfeature | | |
| Feature | | | Feature | | | Feature |
| Control | Size | Depth | Control | Size | Depth | Control |
| Frame | Tolerance | Tolerance | Frame | Tolerance | Tolerance | Frame |
| ◯ | | | | X | | |
| ◯ | X | | | X | | |
| ◯ | X | X | | X | | |
| ◯ | X | | X | X | | |
| ◯ | X | X | X | X | | |
| ◯ | | | X | X | | |
| ◯ | | | | | | X |
| ◯ | X | | | | | X |
| ◯ | X | X | | | | X |
| ◯ | X | | X | | | X |
| ◯ | X | X | X | | | X |
| ◯ | | | X | | | X |
| ◯ | | | | X | | X |
| ◯ | X | | | X | | X |
| ◯ | X | X | | X | | X |
| ◯ | X | | X | X | | X |
| ◯ | X | X | X | X | | X |
| ◯ | | | X | X | | X |
| ◯ | | | | X | X | |
| ◯ | X | | | X | X | |
| ◯ | X | X | | X | X | |
| ◯ | X | | X | X | X | |
| ◯ | X | | X | X | X | |
| ◯ | | | X | X | X | |
| ◯ | | | | X | X | X |
| ◯ | X | | | X | X | X |
| ◯ | X | X | | X | X | X |
| ◯ | X | | X | X | X | X |
| ◯ | X | X | X | X | X | X |
| ◯ | | | X | X | X | X |
| ◯ | | | | | | |
| ◯ | X | | | | | |
| ◯ | X | X | | | | |
| ◯ | X | | X | | | |
| ◯ | X | X | X | | | |
| ◯ | | | X | | | |

| Countersink | | | | | | | |
|---|---|---|---|---|---|---|---|
| Hole | | | | | | | |
| Complex | | | Countersink Planar | | | | |
| Tolerance | Countersink | | Cross Section | | | | |
| Feature | Subfeature | | Sub feature | | Hole Subfeature | | |
| Feature | | Feature | | Feature | | | Feature |
| Control | Angle | Control | Size | Control | Size | Depth | Control |
| Frame | Tolerance | Frame | Tolerance | Frame | Tolerance | Tolerance | Frame |
| ◯ | ◯ | ◯ | | | X | | |
| ◯ | ◯ | ◯ | X | | X | | |
| ◯ | ◯ | ◯ | X | X | X | | |
| ◯ | ◯ | ◯ | | X | X | | |
| ◯ | ◯ | ◯ | | | | | X |
| ◯ | ◯ | ◯ | X | | | | X |
| ◯ | ◯ | ◯ | X | X | | | X |
| ◯ | ◯ | ◯ | | X | | | X |
| ◯ | ◯ | ◯ | | | X | X | X |
| ◯ | ◯ | ◯ | X | | X | X | X |
| ◯ | ◯ | ◯ | X | X | X | X | X |
| ◯ | ◯ | ◯ | | X | X | X | X |
| ◯ | ◯ | ◯ | | | X | X | |
| ◯ | ◯ | ◯ | X | | X | X | |
| ◯ | ◯ | ◯ | X | X | X | X | |
| ◯ | ◯ | ◯ | | X | X | X | |
| ◯ | ◯ | ◯ | | | X | X | X |
| ◯ | ◯ | ◯ | X | | X | X | X |
| ◯ | ◯ | ◯ | X | X | X | X | X |
| ◯ | ◯ | ◯ | | X | X | X | X |
| ◯ | ◯ | ◯ | | | | | |
| ◯ | ◯ | ◯ | X | | | | |
| ◯ | ◯ | ◯ | X | X | | | |
| ◯ | ◯ | ◯ | | X | | | |

◯ Tolerance may or may not exist,
X Tolerance exists

In general, the exemplary tables above describe several different complex tolerances for a complex feature 210. As described above, a complex tolerance may include two or more child tolerances. The complex tolerance may also include its own tolerances. However, the system limits the sets of valid complex tolerances for a particular complex feature 210.

For example, a user may select a first subfeature and associate tolerances with the first subfeature. The user may then select a second subfeature and associate tolerances with the second subfeature. The system may then associate the two subfeatures and their respective tolerances as a complex feature based on the relative geometries, positions, or any other rules that may define a complex feature. The user may then associate tolerances with the complex feature. However, this may result in child tolerances conflicting with one another or with the parent tolerance. Using a rule set from a rule file, the system may restrict the valid set of tolerances for the complex feature to a row described in the exemplary tables above or any other valid set.

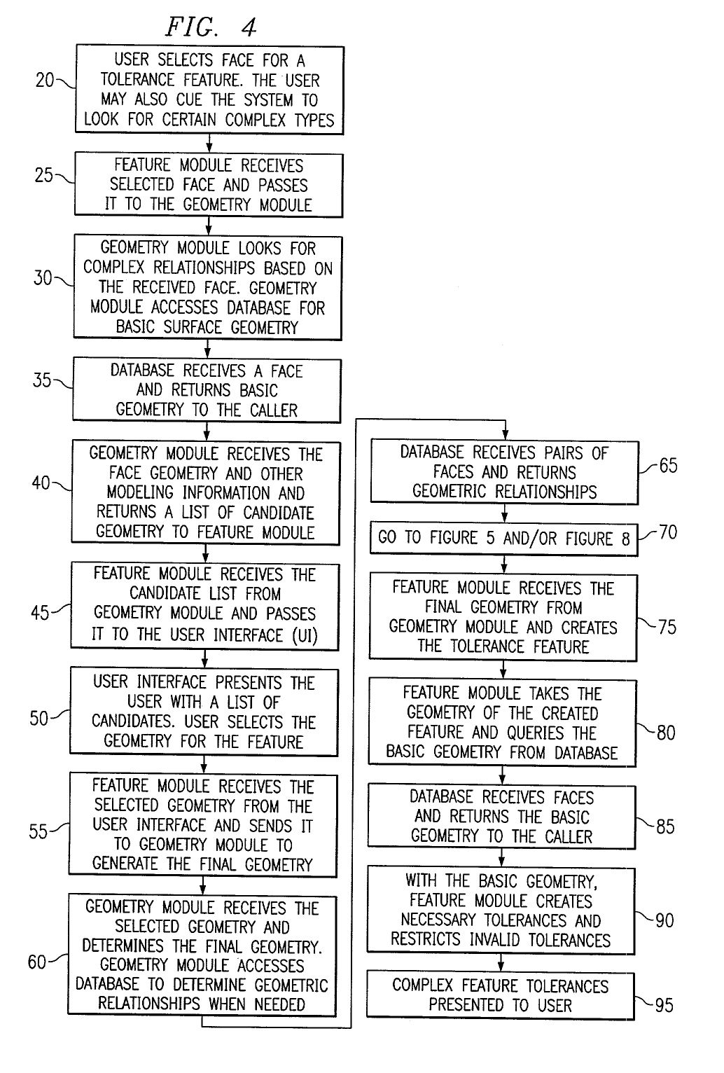

FIG. 4 is a flow diagram illustrating a method for creating a complex feature 210 in accordance with one embodiment of the present invention.

At step 20, the user may select a face 246 for a tolerance subfeature 240 at the user interface level 102. The user may also cue the system to look for certain complex feature 210 types. Next, at step 25, the feature module 106 receives pre-selected face and passes it to the geometry module 107. The geometry module 107 looks for complex relationships based on the received face 246 at step 30. Geometry module 107 further accesses DB module 108 for basic face 246 geometry.

In step 35, the DB module 108 receives the face 246 and returns basic face geometry to the geometry module 107. Next, the geometry module 107 receives the face geometry and other modeling information and returns a list of candidate geometry to feature module 106 at step 40. Once the feature module 106 receives the candidate list from geometry module 107, it passes the list to the user interface 102 at step 45.

At step 50, the user interface 102 presents the user with a list of candidates. The user selects the geometry for the feature. Next, at step 55, the feature module 106 receives the selected geometry from the user interface 102 and sends it to geometry module 107 to generate the final geometry. The geometry module 107 receives the selected geometry and determines the final geometry at step 60. Then, the geometry module 107 accesses DB module 108 to determine the geometric relationships. At step 65, the DB module 108 receives pairs of faces 246 and returns geometric relationships to the geometry module 107.

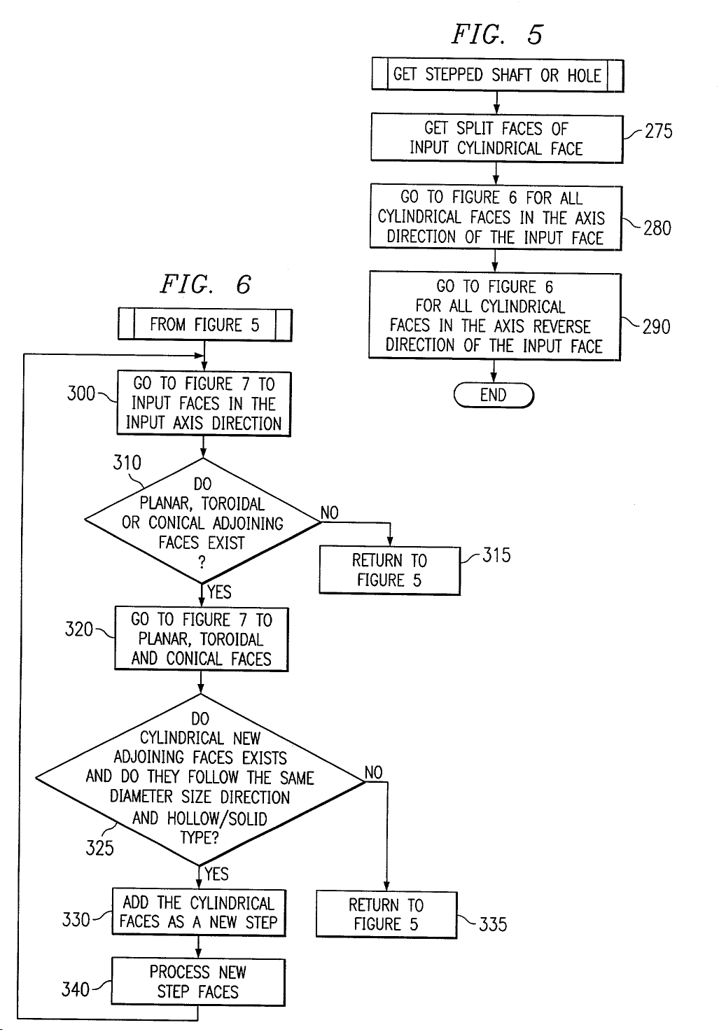

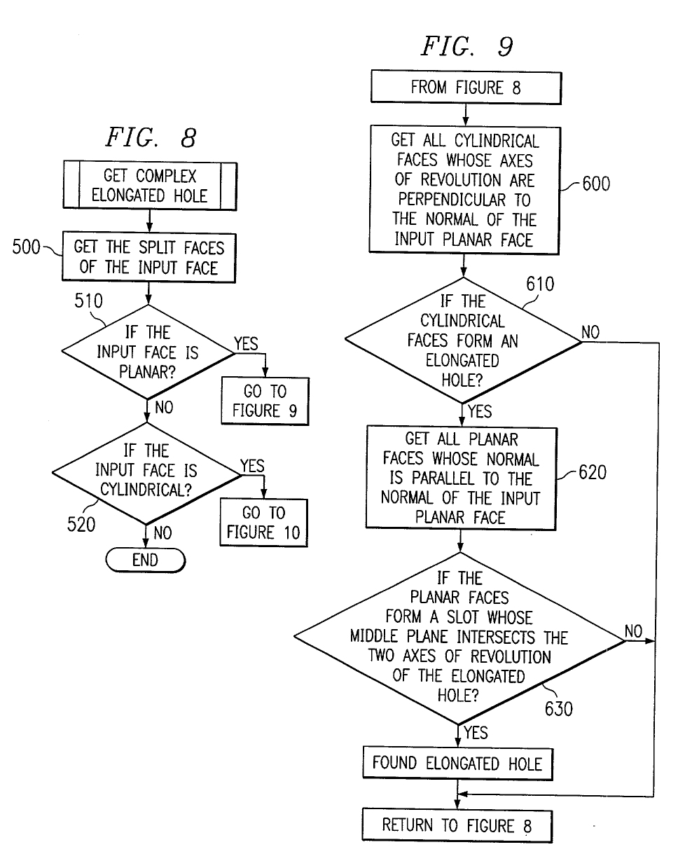

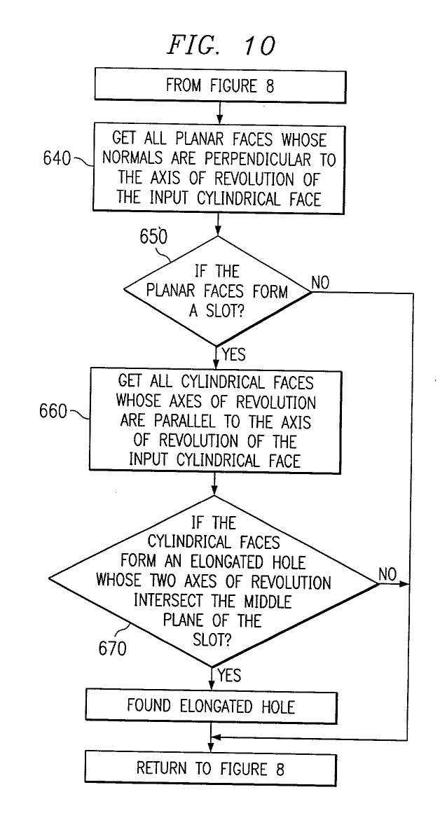

Once the geometric relationships are received by the geometry module 107, the method goes to FIG. 5 and/or FIG. 8 for further processing.

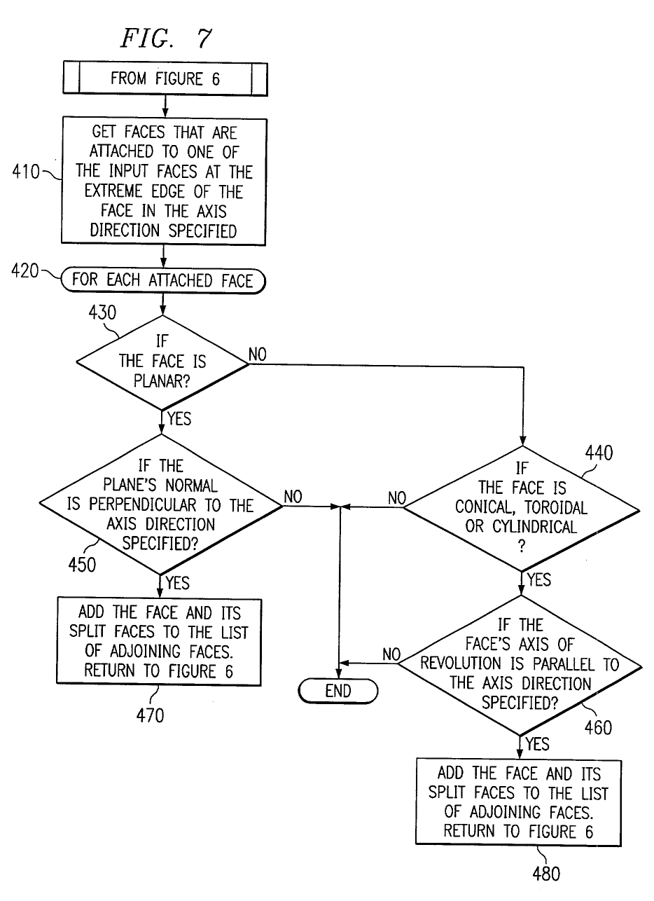

FIG. 5 is a flow diagram illustrating a method for selecting a stepped shaft or hole of the complex feature 210 in accordance with one embodiment of the present invention. At step 275, the geometry module 107 gets stepped split faces of an input cylindrical face. First, the method goes to FIG. 6 for all cylindrical faces in the axis direction of the input face at step 280. Then, at step 290, the method goes to FIG. 6 for all cylindrical faces in the axis reverse direction of the input face.

FIG. 6 is a flow diagram illustrating a method for selecting a cylindrical face of the stepped shaft or hole of FIG. 5 in accordance with one embodiment of the present invention. The method receives the input faces from FIG. 5. At step 300, faces in the input axis direction are processed in FIG. 7.

FIG. 7 is a flow diagram illustrating a method for selecting one or more adjoining faces of the stepped shaft or hole of FIG. 5 in accordance with one embodiment of the present invention. At step 410, the method gets faces that are attached to one of the input faces at the extreme edge of the face in the axis direction specified. Then, for each attached face 420, the method proceeds to decisional step 430.

If the face is not planar, the method proceeds to decisional step 440. Otherwise, the method proceeds to decisional step 450. At step 450, it is determined if the plane's normal is perpendicular to the axis direction specified. If the answer is “Yes”, then the face and its split faces are added to the list of adjoining faces and the method returns to step 300 of FIG. 6. Otherwise, the method ends and returns to step 300 of FIG. 6.

At step 440, the method determines if the face is conical, toroidal or cylindrical. If the answer is “No,” then the method ends and returns to FIG. 6. Otherwise, at step 460, if the face's axis of revolution is parallel to the axis direction specified then the method proceeds to step 480. At step 480, the face and its split faces are added to the list of adjoining faces and the method returns to step 300 of FIG. 6. Otherwise, the method ends and returns to step 300 of FIG. 6

Returning to FIG. 6 at decisional step 310, if planar, toroidal or conical adjoining faces exist then the method proceeds to step 320. Otherwise, it returns to FIG. 5. At step 320, the method goes to FIG. 7 to process the new planar, toroidal and conical adjoining faces. The method proceeds in FIG. 7 as detailed above.

Once the method returns to FIG. 6 at decisional step 325, it determines if a cylindrical new adjoining faces exists and if it follows the same diameter size direction and hollow/solid type. If no new adjoining faces exist, the method returns to FIG. 5. Otherwise, each face is added as a new step at step 330. The method then processes new step faces at step 340. Once complete, the method returns to FIG. 4.

FIG. 8 is a flow diagram illustrating a method for selecting an elongated hole of the complex feature of 210 in accordance with one embodiment of the present invention. The method in FIG. 8 will find a complex elongated hole by getting the split faces of the input face 500.

First, at decisional step 510, if the input face is not planar, proceed to step 520. If the input face is planar, go to FIG. 9. FIG. 9 is a flow diagram illustrating a method for selecting the elongated hole faces from one planar face of the complex feature of FIG. 8 in accordance with one embodiment of the present invention.

Using the input face from FIG. 8, the method retrieves all cylindrical faces whose axes of revolution are perpendicular to the normal of the input planar face at step 600. Next, at decisional step 610, if the cylindrical faces do not form an elongated hole, then the method returns to FIG. 8. Otherwise, at step 620, the method will get all planar faces whose normal is parallel to the normal of the input planar face. The method then determines if the planar faces from a slot whose middle plane intersects the two axes of revolution of the elongated hole at decisional step 630. If the answer is “No”, then it returns to FIG. 8. Otherwise a complex elongated hole was found and returned to FIG. 8.

Returning to FIG. 8, at decisional step 520, the method determines if the input face is cylindrical. If it is not, the method ends and returns to FIG. 4. Otherwise, it proceeds to FIG. 10.

FIG. 10 is a flow diagram illustrating a method for selecting the elongated hole faces from one cylindrical face of the complex feature of FIG. 8 in accordance with one embodiment of the present invention.

Using the input cylindrical face from FIG. 8, the method gets all planar faces whose normals are perpendicular to the axis of revolution of the input cylindrical face at step 640. At decisional step 650, if the planar faces do not form a slot, then the method ends and returns to FIG. 8. Otherwise, if the planar faces form a slot, then the method retrieves all of the cylindrical faces whose axes of revolution are parallel to the axis of revolution of the input cylindrical face. Next, at decisional step 670, if the cylindrical faces form an elongated hole whose two axes of revolution intersect the middle plane of the slot, then an elongated hole is found and returned to FIG. 8.

After either the processing of the method in FIG. 9 or FIG. 10 is complete, then the method of FIG. 8 returns to FIG. 4.

Returning to FIG. 4, at step 75, the feature module 106 receives the final geometry from geometry module 107 and defines the complex feature 210. Next, the feature module 106 takes the geometry of the created feature and queries the basic face geometry from DB module 108 at step 80. At step 85, the DB module 108 receives faces 246 and returns the basic face geometry to the feature module 106. With the basic face geometry, feature module 106 creates necessary tolerances and restricts invalid tolerances at step 90. To restrict invalid tolerances, the feature module 106 may use parameters including the type of complex feature 210 created, the geometry of the complex feature 210 (including the form, number of surfaces, any refinements to the geometry), whether or not the complex feature 210 is a pattern, tolerances that are already applied to the complex feature 210, and tolerances already applied to the child tolerances. The method ends when the complex feature 210's tolerances are presented to the user at step 95.

Although the present invention has been described in detail, it should be understood that various changes, substitutions and alterations can be made hereto without departing from the sphere and scope of the invention as defined by the appended claims.

To aid the Patent Office, and any readers of any patent issued on this application in interpreting the claims appended hereto, applicants wish to note that they do not intend any of the appended claims to invoke ¶6 of 35 U.S.C. §112 as it exists on the date of filing hereof unless “means for” or “step for” are used in the particular claim.

What is claimed is:

1. A method for processing a complex feature, comprising:
selecting a first feature, wherein the first feature comprises a plurality of faces;
selecting a second feature, wherein the second feature comprises a plurality of faces;
automatically determining the presence of a complex feature based on a relationship of the selected first and second features; and
determining one or more tolerances of the complex feature.

2. The method of claim 1, wherein automatically determining the presence of the complex feature comprises:
determining whether the first feature adjoins the second feature; and
determining the existence of an axial relationship between the adjoined first and second feature.

3. The method of claim 2, wherein determining the existence of the axial relationship between the adjoined first and second feature comprises determining if a normal of a planar face of the first feature is perpendicular to an axis of the second feature.

4. The method of claim 2, wherein determining the existence of the axial relationship between the adjoined first and second feature comprises determining if an axis of revolution of a conical or toroidal face of the first feature is parallel to an axis of the second feature.

5. The method of claim 1, wherein a face is selected from the set consisting of:
a planar face;
a toroidal face;
a conical face; and
a cylindrical face.

6. The method of claim 1, wherein the complex feature is selected from the set consisting of:
a counterbore hole feature;
a countersink hole feature;
an edge blend feature; and
an elongated hole feature.

7. The method of claim 6, wherein the complex feature comprises the counterbore hole feature and the tolerances comprise one or more of the following:
a hole diameter tolerance;
a hole depth tolerance;
one of a position, form, orientation, or runout tolerance;
a counterbore hole diameter tolerance;
a counterbore hole depth tolerance; and
an axis tolerance.

8. The method of claim 6, wherein the complex feature comprises the countersink hole feature and the tolerances comprise one or more of the following:
a hole diameter tolerance;
a hole depth tolerance;
a position tolerance;
a countersink hole diameter tolerance; and
an axis tolerance.

9. The method of claim 1, wherein determining one or more tolerances of the complex feature comprises automatically restricting invalid tolerances.

10. The method of claim 1, wherein selecting the second feature comprises automatically selecting a second feature.

11. The method of claim 1, wherein determining one or more tolerances of the complex feature comprises:
determining one or more tolerances of the first feature and one or more tolerances of the second feature; and
associating the determined tolerances of the first feature and the determined tolerances of the second feature.

12. The method of claim 1 further comprising displaying the complex feature and the tolerances.

13. A system for processing a complex feature, the system comprising logic encoded in media and operable to:
select a first feature, wherein the first feature comprises a plurality of faces;
select a second feature, wherein the second feature comprises a plurality of faces;
automatically determine the presence of a complex feature based on a relationship of the selected first and second features; and
determine one or more tolerances of the complex feature.

14. The system of claim 13, wherein the logic operable to automatically determine the presence of the complex feature comprises logic operable to:
determine whether the first feature adjoins the second feature; and
determine the existence of an axial relationship between the adjoined first and second feature.

15. The system of claim 14, wherein the logic operable to determine the existence of the axial relationship between the adjoined first and second feature comprises the logic operable to determine if a normal of a planar face of the first feature is perpendicular to an axis of the second feature.

16. The system of claim 14, wherein the logic operable to determine the existence of the axial relationship between the adjoined first and second feature comprises the logic operable to determine if an axis of revolution of a conical or toroidal face of the first feature is parallel to an axis of the second feature.

17. The system of claim 13, wherein the face is selected from the set consisting of:
a planar face;
a toroidal face;
a conical face; and
a cylindrical face.

18. The system of claim 13, wherein the complex feature is selected from the set consisting of:
a counterbore hole feature;
a countersink hole feature;
an edge blend feature; and
an elongated hole feature.

19. The system of claim 18, wherein the complex feature comprises the counterbore hole feature and the tolerances comprise one or more of the following:
a hole diameter tolerance;
a hole depth tolerance;
one of a position, form, orientation, or runout tolerance;
a counterbore hole diameter tolerance;
a counterbore hole depth tolerance; and
an axis tolerance.

20. The system of claim 18, wherein the complex feature comprises the countersink hole feature and the tolerances comprise one or more of the following:
a hole diameter tolerance;
a hole depth tolerance;
a position tolerance;
a countersink hole diameter tolerance; and
an axis tolerance.

21. The system of claim 13, wherein the logic operable to determine one or more tolerances of the complex feature comprises the logic operable to automatically restrict invalid tolerances.

22. The system of claim 13, wherein the logic operable to select the second feature comprises the logic operable to automatically select a second feature.

23. The system of claim 13, wherein the logic operable to determine one or more tolerances of the complex feature comprises the logic operable to determine one or more tolerances of the first feature and one or more tolerances of the second feature and to associate the determined tolerances of the first feature and the determined tolerances of the second feature.

24. The system of claim 12, further comprising the logic operable to display the complex feature and the tolerances.

25. A system for processing a complex feature, comprising:
a user interface operable to:
select a first feature, wherein the first feature comprises a plurality of faces,
select a second feature, wherein the second feature comprises a plurality of faces,
display a complex feature and one or more tolerances of the complex feature;
a feature module operable to determine the tolerances of the complex feature;
a geometry module operable to automatically determine the presence of the complex feature based on a relationship of the selected first and second features; and
a database module operable to store face geometry of a plurality of features.

26. The system of claim 25, wherein the geometry module operable to automatically determine the presence of the complex feature comprises a geometry module operable to:
determine whether the first feature adjoins the second feature; and
determine the existence of an axial relationship between the adjoined first and second feature.

27. The system of claim 25, wherein the feature module operable to determine the tolerances of the complex feature comprises a feature module operable to automatically restrict invalid tolerances.

28. The system of claim 25, wherein the feature module operable to determine the tolerances of the complex feature comprises a feature module operable to determine one or more tolerances of the first feature and one or more tolerances of the second feature and to associate the determined tolerances of the first feature and the determined tolerances of the second feature.
